(19) United States
(12) Patent Application Publication
(10) Pub. No.: US 2026/0222929 A1
(43) Pub. Date: Jul. 30, 2026

(54) METHODS AND WIRELESS NETWORK FOR HANDLING UE TIMERS WITH LTM SCENARIO IN WIRELESS NETWORK

(71) Applicant: SAMSUNG ELECTRONICS CO., LTD., Suwon-si, Gyeonggi-do (KR)

(72) Inventor: Aby Kanneath ABRAHAM, Bangalore (IN)

(21) Appl. No.: 19/147,242

(22) PCT Filed: Jan. 10, 2024
(86) PCT No.: PCT/KR2024/000502

§ 371 Date: Jul. 10, 2025

(30) Foreign Application Priority Data
Jan. 10, 2023 (IN) 202341002015
Mar. 15, 2023 (IN) 202341017580
Dec. 23, 2023 (IN) 202341002015

(51) Int. Cl. H04W 36/00; H04W 76/19

(52) U.S. Cl. CPC H04W 36/00835; H04W 36/0077; H04W 76/19

(57) ABSTRACT

The disclosure relates to a 5G or 6G communication system for supporting a higher data transmission rate. A method by a user equipment (UE) in a wireless communication system, the UE comprising: receiving, from a base station, a control message including a lower layer triggered mobility (LTM) configuration comprising a timer per candidate cell per cell group, receiving, from the base station, an LTM cell switch command, starting the timer for an LTM cell switch in an LTM candidate configuration upon reception of the LTM cell switch command.

### TECHNICAL FIELD

Embodiments disclosed herein relate to wireless networks, and more particularly to method for managing User Equipment (UE) timers and counters with Lower Layer Triggered Mobility (LTM) in the wireless networks.

### BACKGROUND ART

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultrahigh-performance communication and computing resources.

In wireless technologies like fifth generation (5G) new radio (NR), devices can move across different cells. Mobility is performed using a procedure called cell reselection in an RRC_IDLE mode. Till NR R17, the mobility is performed using a procedure called handover in an RRC_CONNECTED mode. Network controlled mobility applies to UEs in the RRC_CONNECTED. It requires an explicit RRC signalling to be triggered by a gNB in the NR. The handover in the NR usually comprises of three steps: handover preparation step, handover execution step and handover completion step.

### DISCLOSURE OF INVENTION

### Technical Problem

The present disclosure relates to wireless communication systems and, more specifically, the invention relates to methods and wireless network for handling UE timers with LTM scenario in wireless network.

The principal object of the embodiments herein is to disclose methods and systems for managing UE timers with LTM in a wireless network (or wireless communication network).

Another object of the embodiments herein is to handle of Tcellswitchtimer during various operations (start/stop/expiry etc.) of the UE.

Another object of the embodiments herein is to handle a RRC timer (such as, but not limited to, NR timers T304, T310, T312, T321, T322, T350 and T390 or their equivalent in any other wireless technology) during cell switch.

Another object of the embodiments herein is to disclose methods and systems for detection of physical layer problems and recovery from physical layer problems in an RRC_CONNECTED.

Another object of the embodiments herein is to handle various counters such as N310 and N311 during the cell switch.

Another object of the embodiments herein is to handle an independent counter (COUNT) for each radio bearer during cell switch and configuring the cell switch timer.

### Solution to Problem

Accordingly, the embodiments herein provide a method for handling a timer of a UE during a LTM scenario in a wireless network. The method includes receiving, by the UE, a LTM configuration including a timer per candidate cell per cell group from a network entity. Further, the method includes receiving, by the UE, a LTM cell switch command from the network entity. Further, the method includes starting, by the UE, the timer for a LTM cell switch in a LTM candidate configuration upon reception of the LTM cell switch command. Further, the method includes performing, by the UE, at least one action upon determining at least one of: an expiry of the timer, stopping the timer, and running the timer.

In an embodiment, the at least one action includes at least one of: stopping the timer upon successful completion of random access on a corresponding Spcell, stopping the timer upon successfully performing uplink (UL) transmission to indicate successful completion of a LTM when the LTM is performed without random access, stopping the timer upon a Secondary Cell Group (SCG) layer 3 mobility, stopping the timer for the MCG upon performing the MCG layer 3 mobility, stopping the timer upon receiving a RRC message modifying LTM configuration, stopping the timer upon receiving a RRC message modifying a candidate cell configuration for a candidate cell to which the UE is performing the LTM cell switch, stopping the timer upon receiving the RRC message modifying or releasing LTM reference configuration, stopping the timer upon at least one of a security key update, a SCG upon security key update and a MCG upon security key update, stopping the timer upon receiving the RRC message including at least one of a masterKeyUpdate and SN counter, stopping the timer for one of: the SCG and MCG upon receiving the RRC message including at least one of the masterKeyUpdate and the SN counter, stopping the timer upon receiving a MobilityFromNRCommand from the network entity, stopping the timer upon reception of RRCRelease, and stopping the timer for the SCG upon SCG release.

In an embodiment, the at least one action includes at least one of ignoring a SCG L3 mobility initiation while the timer is running, ignoring a MCG L3 mobility initiation while the timer for one of: a SCG and a MCG is running, ignoring at least one of a security key update, a security key update for SCG and a security key update for MCG while the timer is running, ignoring a RRC message upon determining at least one of: modifying LTM configuration or releasing LTM configuration of the candidate cell to which the UE is performing cell switch, modifying or releasing a candidate cell configuration for the candidate cell to which the UE is performing cell switch or modifying or releasing LTM reference configuration, while the timer is running, and ignoring a RRC message for a CPAC execution condition satisfaction for one of: the SCG and the MCG, while the timer is running.

In an embodiment, the at least one action includes at least one of sending at least one of: a RRCReestablishment and MCGFailureInformation for a MCG to the network entity upon determining that timer is expired for MCG, and sending a SCGFailureInformation for the SCG upon determining the timer is expired for SCG.

In an embodiment, the timer is a Tcellswitch, where the timer is configured for each cell group and at least one possible value of the Tcellswitch is ms50, ms100, ms150, ms200, ms500, ms1000, ms2000, and ms10000.

Accordingly, the embodiments herein provide a method for handling a timer of a UE during a LTM scenario in a wireless network. The method includes receiving, by the UE, a LTM configuration including a first timer from a network entity. Further, the method includes starting, by the UE, a second timer. Further, the method includes receiving, by the UE, a LTM cell switch command from the network entity. Further, the method includes starting, by the UE, the first timer for a LTM cell switch based on the LTM cell switch command. In an embodiment, the method includes stopping the second timer upon determining that the LTM cell switch command is for a corresponding SpCell. The UE may perform the steps for stopping the second timer after receiving the cell switch before executing cell switch command, along with the various steps for the execution of cell switch command or after the successful completion of cell switch command. In another embodiment, the method includes performing at least one of: restarting a counter N310 by setting a value of counter N310 to zero and resetting a counter N311 upon determining that the LTM cell switch command is for a corresponding SpCell.

In an embodiment, the second timer includes at least one of: a T310, a T312, a T350, a T390, a T321, and a T322.

In an embodiment, the UE restarts a detection of physical layer problems upon receiving the cell switch command.

Accordingly, the embodiments herein provide a UE including a LTM based timer controller coupled with a processor and a memory. The LTM based timer controller is configured to receive a LTM configuration including a first timer per candidate cell per cell group from a network entity. Further, the LTM based timer controller is configured to receive a LTM cell switch command from the network entity. Further, the LTM based timer controller is configured to start a timer for a LTM cell switch in a LTM candidate configuration upon reception of the LTM cell switch command. Further, the LTM based timer controller is configured to perform at least one action upon determining at least one of: an expiry of the timer, stopping the timer and running the timer.

Accordingly, the embodiments herein provide a UE including a LTM based timer controller coupled with a processor and a memory. The LTM based timer controller is configured to receive a LTM configuration including a first timer from a network entity. Further, the LTM based timer controller is configured to start a second timer. Further, the LTM based timer controller is configured to receive a LTM cell switch command from the network entity. Further, the LTM based timer controller is configured to start the first timer for a LTM cell switch based on the LTM cell switch command. In an embodiment, the LTM based timer controller is configured to stop the second timer upon determining that the LTM cell switch command is for a corresponding SpCell. In another embodiment, the LTM based timer controller is configured to perform at least one of: restart a counter N310 by setting a value of counter N310 to zero and resetting a counter N311 upon determining that the LTM cell switch command is for a corresponding SpCell.

Accordingly, the embodiments herein provide a method for handling a timer of a UE during a LTM scenario in a wireless network. The method includes determining, by a network entity, a LTM configuration comprising a first timer for each candidate cell of each cell group. Further, the method includes sending, by the network entity, the LTM configuration comprising the first timer to a UE. Further, the method includes sending, by the network entity, a LTM cell switch command to the UE. Further, the method includes receiving, by the network entity, a RRCReconfigurationComplete message form the UE based on the LTM cell switch command.

Accordingly, the embodiments herein provide a network entity including a LTM based timer controller coupled with a processor and a memory. The LTM based timer controller is configured to determine a LTM configuration comprising a first timer for each candidate cell of each cell group. Further, the LTM based timer controller is configured to send the LTM configuration comprising the first timer to the UE. Further, the LTM based timer controller is configured to send a LTM cell switch command to the UE (100). Further, the LTM based timer controller is configured to receive a RRCReconfigurationComplete message form the UE based on the LTM cell switch command.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

In an embodiment, a method by a user equipment (UE) in a wireless communication system, the method comprising: receiving, from a base station, a control message including a lower layer triggered mobility (LTM) configuration comprising a timer per candidate cell per cell group, receiving, from the base station, an LTM cell switch command, and starting the timer for an LTM cell switch in an LTM candidate configuration upon reception of the LTM cell switch command.

In another embodiment, a method by a base station in a wireless communication system, the method comprising: transmitting, to user equipment (UE), a control message including a lower layer triggered mobility (LTM) configuration comprising a timer per candidate cell per cell group, and transmitting, to the UE, an LTM cell switch command, wherein the UE start the timer for an LTM cell switch in an LTM candidate configuration upon reception of the LTM cell switch command.

In yet another embodiment, a user equipment (UE) associated with a first cell group and a second cell group in a wireless communication system, the UE comprising: a transceiver; and a processor configured to: receive, from a base station, a control message including a lower layer triggered mobility (LTM) configuration comprising a timer per candidate cell per cell group, receive, from the base station, an LTM cell switch command, start the timer for an LTM cell switch in an LTM candidate configuration upon reception of the LTM cell switch command.

In yet another embodiment, a base station in a wireless communication system, the base station comprising: a transceiver; and a processor configured to: transmit, to user equipment (UE), a control message including a lower layer triggered mobility (LTM) configuration comprising a timer per candidate cell per cell group; and transmit, to the UE, an LTM cell switch command, wherein the UE start the timer for an LTM cell switch in an LTM candidate configuration upon reception of the LTM cell switch command.

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for handling a timer of a UE during a LTM scenario in the wireless network, according to the embodiments as disclosed herein;

FIG. 2a shows various hardware components of the UE, according to the embodiments as disclosed herein;

FIG. 2b shows various hardware components of a network entity, according to the embodiments as disclosed herein;

FIG. 3 and FIG. 4 are flow charts illustrating a method, implemented by the UE, for handling a timer of the UE during the LTM scenario in the wireless network, according to the embodiments as disclosed herein;

FIG. 5 is a flow chart depicting a process of starting and stopping a Tcellswitch, according to embodiments as disclosed herein;

FIG. 6 is a flow chart depicting a scenario, where the Tcellswitch has expired, according to embodiments as disclosed herein;

FIG. 7 is a flow chart depicting a process of handling a UE timer during cell switch, according to embodiments as disclosed herein;

FIG. 8 is a flow chart depicting the process of handling N310 and N311 counters during LTM, according to embodiments as disclosed herein;

FIG. 9 is a flow chart depicting a process of detecting problems with the physical layers, according to embodiments as disclosed herein; and

FIG. 10 is a flow chart illustrating a method, implemented by the network entity, for handling the timer of the UE during the LTM scenario in the wireless network, according to the embodiments as disclosed herein.

### MODE FOR THE INVENTION

The gNB may configure the UE to report measurements and based on the reported measurements or based on its own understanding of a network topology, the gNB will send a RRC Reconfiguration message to handover the UE to another cell (hereinafter referred to as a target cell) from a source cell. The UE accesses the target cell and sends a RRC Reconfiguration complete message. In an alternative way (introduced in Third Generation Partnership Project (3GPP) NR release 16), the gNB may configure the UE with execution conditions for triggering handover and once the execution conditions are satisfied, the UE may move to the target cell and send the RRC Reconfiguration complete. The 3GPP also introduced a new handover called Dual Active Protocol Stack (DAPS) handover in release 16. In all these methods, the UE performs handover by sending layer 3 (RRC) messages which causes considerable signalling overhead and latency issues. The handover, and conditional handover (CHO) are referred to herein as layer 3 mobility. In case of dual connectivity, the UE may perform PSCellChange or Conditional PSCellChange. In the context of the dual connectivity, PSCellChange or Conditional PSCellChange can also be referred to as layer 3 mobility. That is, Handover, Conditional Handover, PSCellChange, Conditional PSCellChange etc. refers to L3 mobility. The PSCellChange or the Conditional PSCellChange can be referred to as Secondary Cell Group (SCG) layer 3 mobility and the handover and CHO can be referred to as Master Cell Group (MCG) layer 3 mobility in the context of dual connectivity. The UE may perform the L3 mobility upon reception of the RRC reconfiguration message asking the UE to perform handover, or upon execution of the conditional reconfiguration (CHO, CPA (Conditional PSCell Addition) or CPC).

Further, the UE may receive the RRC configuration for updating some of the security parameters. The 3GPP specifications such as TS38.300, TS38.331, TS 38.321 V17.2.0 can be considered as relevant background in the context of this description.

The UE may also start a number of RRC timer(s) according to TS 38.331 due to various events. The timers such as T304 or T310 or T312 or T350 or T390 or T321 or T322 and events referred in the patent disclosure are described in detail in TS38.331 section 7.1.1. In NR R17, T304 is used for guarding L3 handover. The T304 is started upon reception of RRCReconfiguration message including reconfigurationWithSync for the MCG which does not include s1-PathSwitchConfig, or upon reception of RRCReconfiguration message including reconfigurationWithSync for the SCG not indicated as deactivated in the NR or E-UTRA message containing the RRCReconfiguration message or upon conditional reconfiguration execution i.e. when applying a stored RRCReconfiguration message including reconfigurationWithSync and is stopped upon successful completion of random access on the corresponding SpCell or for T304 of SCG, upon SCG release. T310 and T312 are used for handling physical layer problem for the primary cell. In NR 17, T310 is started upon detecting physical layer problems for the SpCell (primary cell) i.e. upon receiving N310 consecutive out-of-sync indications from lower layers. T310 is stopped upon receiving N311 consecutive in-sync indications from lower layers for the SpCell, upon receiving RRCReconfiguration with reconfigurationWithSync for that cell group, upon reception of MobilityFromNRCommand, upon the reconfiguration of rlf-TimersAndConstant, upon initiating the connection re-establishment procedure, upon conditional reconfiguration execution i.e. when applying a stored RRCReconfiguration message including reconfigurationWithSync for that cell group, and upon initiating the MCG failure information procedure. T310 in SCG is stopped upon SCG release. T312 is started upon triggering a measurement report for a measurement identity for which T312 has been configured. Stop conditions for T312 are similar to that of T310. Timer T350 is started upon requesting on demand system information (OSI) and is stopped upon receiving OSI. Timer T390 handle the access barring. T390 is started when access attempt is barred and is stopped upon cell selection, reselection, upon relay (re)selection, upon entering RRC_CONNECTED etc. Timer T321 is for measurements for reporting Cell Global Identity and T322 is for measurements for reporting SFTD (System Frame Number Time Difference). Operations of RRC timers are not affected by the beam mobility. The definitions, description, operations, functionality including the criteria for starting or stopping or expiry of the above timers as described in TS38.331 v17.2.0 can be considered as background.

The 3GPP release 18 is considering Lower Layers (L1/L2 layers) Triggered Mobility (also known as LTM) to solve the problem related to latency, signalling overhead etc. associated with the layer 3 mobility. In 3gpp technologies like NR, traditionally L1/L2 mobility is used for beam switching (beam level mobility). As per 3GPP, the goal of LTM is to enable a serving cell change via L1/L2 signalling, in order to reduce the latency, overhead and interruption time. The network (e.g., gNB) may configure the UE with multiple candidate cells to allow fast application of configurations for the candidate cells. The network may further send the MAC CE or L1 signalling to dynamically switch the UE from the source cell to one of the configured candidate cells. Further, the LTM can be triggered based on L1 measurements rather than L3 measurements.

The 3GPP proposes to perform LTM, without reset of lower layers like Medium Access Control (MAC) to avoid data loss and to reduce the additional delay of data recovery wherever it is possible.

The gNB may provide LTMCandidateConfiguration; i.e., configure LTM candidate cells through one RRCReconfiguration message for the candidate target cell or through one CellGroupConfig for each candidate target cell or through any similar RRC structure or IE containing the similar fields (for e.g., a new IE LTM-CandidateConfig can be defined as ASN.1 sequence containing CellGroupConfig and some other information elements in the RRCReconfiguration). The gNB may further release or modify the candidate configurations. The UE may store the LTM configuration of other candidate cells even after moving to a candidate cell through the LTM. The gNB also may provide the UE with configuration for performing LTM measurements for different candidate frequencies and candidate cells and reporting based on the performed LTM measurements.

Measurement Configuration: A NR R17 UE can be configured with MeasConfig IE for performing layer 3 measurements. R17 v17.2.0 NR specification defines MeasConfig as below.

MeasConfig ::= SEQUENCE {
measObjectToRemoveList MeasObjectToRemoveList OPTIONAL, -- Need N
measObjectToAddModList MeasObjectToAddModList OPTIONAL, -- Need N
reportConfigToRemoveList ReportConfigToRemoveList OPTIONAL, -- Need N
reportConfigToAddModList ReportConfigToAddModList OPTIONAL, -- Need N
measIdToRemoveList MeasIdToRemoveList
OPTIONAL, -- Need N
measIdToAddModList MeasIdToAddModList
OPTIONAL, -- Need N
s-MeasureConfig CHOICE {
ssb-RSRP RSRP-Range,
csi-RSRP RSRP-Range
} OPTIONAL, -- Need M
quantityConfig QuantityConfig
OPTIONAL, -- Need M
measGapConfig MeasGapConfig
OPTIONAL, -- Need M
measGapSharingConfig MeasGapSharingConfig
OPTIONAL, -- Need M
...,
[[
interFrequencyConfig-NoGap-r16 ENUMERATED {true}
OPTIONAL -- Need R
]]
}

Additional details and definitions of all the parameters for MeasConfig have been described in TS 38.331 V17.2.0.

LTM measurements: The UE can be configured by the gNB with different measurement configurations for both layer 3 mobility (for e.g., using MeasConfig IE in R17 NR) and the LTM. The UE which has been configured with measurement configurations for the layer 3 mobility (Measurements configured/performed/reported for layer 3 mobility; for e.g., configured through R17 MeasConfig IE, is here in after referred as L3 measurements) and LTM (Measurements configured/performed/reported for LTM is here in after referred as LTM measurements), performs both L3 measurements and LTM measurements. LTM measurements are L1 measurements.

The L1 measurement report for the LTM is reported as periodic measurement report on Physical Uplink Control Channel (PUCCH), semi-persistent measurement report on the PUCCH/Physical Uplink Shared Channel (PUSCH), and aperiodic measurement report on PUSCH. Further, the L1 measurements can be reported using the MAC CE. This reports may be scheduled by gNB or initiated by the UE. It is also possible that gNB can decide to trigger the LTM through uplink (UL) measurements.

Cell Switch command: The gNB instructs the UE to perform the LTM, i.e. to move to target candidate cell through Downlink (DL) MAC CE or through L1 signaling. MAC CE triggering of the cell switch carries LTM related information for cell switch including the cell identifier. The procedure of triggering change of cells via the LTM feature is called cell switch. It is also possible that the LTM trigger occurs due to other actions than the reception of L1 or L2 message from the gNB. In an example, upon the radio link failure, if the UE selects a cell which is a LTM candidate cell, the UE may behave as if LTM is triggered, i.e. perform actions upon reception of LTM cell switch command, if it is configured by the network to do so and all the embodiments related to UE actions for the handling of cell switch command are applicable for this scenario too. Both RACH-based (contention free random access (CFRA), contention based random access (CBRA)) and RACH-less procedures for cell switch are supported. RACH-less cell switch may be used if the UE doesn't need to acquire TA during the cell switch. The RACH resource for CFRA for cell switch can be provided in RRC configuration to the UE.

The UE arrival in the target cell will be indicated to the network by uplink signaling, either L1/MAC signaling or RRC signaling.

Further, the cell switch can be completed once the UE successfully completes random access for RACH based cell switch. For RACH less cell switch, cell switch may be completed once a UL transmission is successful (for e.g., the UL transmission for indicating arrival or any data transfer in the target cell). The LTM can be supported in dual connectivity, such as NR-DC also.

The above information is presented as background information only to help the reader to understand the present invention. Applicants have made no determination and make no assertion as to whether any of the above might be applicable as prior art with regard to the present application.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

In wireless technologies, the gNB provides a reference configuration, a L1 measurement configuration and a candidate cell configuration in a RRC ASN.1 SEQUENCE used for LTM Configuration. An example sequence is given as below:

```
  ASN1START
  TAG-RRCRECONFIGURATION-START
  RRCReconfiguration ::= SEQUENCE {
  rrc-TransactionIdentifier RRC-TransactionIdentifier,
  criticalExtensions CHOICE {
  rrcReconfiguration RRCReconfiguration-Ies,
  criticalExtensionsFuture SEQUENCE { }
  }
  }
  RRCReconfiguration-Ies ::= SEQUENCE {
  radioBearerConfig RadioBearerConfig
  OPTIONAL, -- Need M
  secondaryCellGroup OCTET STRING (CONTAINING CellGroupConfig)
OPTIONAL, -- Cond SCG
  measConfig MeasConfig
  OPTIONAL, -- Need M
  lateNonCriticalExtension OCTET STRING
  OPTIONAL,
  nonCriticalExtension RRCReconfiguration-v1530-Ies
  OPTIONAL
  }
  RRCReconfiguration-v1530-Ies ::= SEQUENCE {
  masterCellGroup OCTET STRING (CONTAINING CellGroupConfig) OPTIONAL,
-- Need M
  fullConfig ENUMERATED {true}
  OPTIONAL, -- Cond FullConfig
  dedicatedNAS-MessageList SEQUENCE (SIZE(1..maxDRB)) OF DedicatedNAS-
Message OPTIONAL, -- Cond nonHO
  masterKeyUpdate MasterKeyUpdate
  OPTIONAL, -- Cond MasterKeyChange
  dedicatedSIB1-Delivery OCTET STRING (CONTAINING SIB1) OPTIONAL, --
Need N
  dedicatedSystemInformationDelivery OCTET STRING (CONTAINING SystemIn-
formation) OPTIONAL, -- Need N
  otherConfig OtherConfig OPTIONAL, -- Need M
  nonCriticalExtension RRCReconfiguration-v1540-Ies
  OPTIONAL
  }
  RRCReconfiguration-v1540-Ies ::= SEQUENCE {
  otherConfig-v1540 OtherConfig-v1540
  OPTIONAL, -- Need M
  nonCriticalExtension RRCReconfiguration-v1560-Ies
  OPTIONAL
  }
  RRCReconfiguration-v1560-Ies ::= SEQUENCE {
  mrdc-SecondaryCellGroupConfig SetupRelease { MRDC-Sec-
ondaryCellGroupConfig } OPTIONAL, -- Need M
  radioBearerConfig2 OCTET STRING (CONTAINING RadioBearerConfig)
OPTIONAL, -- Need M
  sk-Counter SK-Counter OPTIONAL, -- Need N
  nonCriticalExtension RRCReconfiguration-v1610-Ies OPTIONAL
  }
  RRCReconfiguration-v1610-Ies ::= SEQUENCE {
  otherConfig-v1610 OtherConfig-v1610
  OPTIONAL, -- Need M
  bap-Config-r16 SetupRelease { BAP-Config-r16 }
  OPTIONAL, -- Need M
  iab-IP-AddressConfigurationList-r16 IAB-IP-AddressConfigurationList-r16
OPTIONAL, -- Need M
  conditionalReconfiguration-r16 ConditionalReconfiguration-r16 OPTIONAL, --
Need M
  daps-SourceRelease-r16 ENUMERATED{true}
  OPTIONAL, -- Need N
  t316-r16 SetupRelease {T316-r16}
  OPTIONAL, -- Need M
  needForGapsConfigNR-r16 SetupRelease {NeedForGapsConfigNR-r16}
OPTIONAL, -- Need M
  onDemandSIB-Request-r16 SetupRelease { OnDemandSIB-Request-r16 }
OPTIONAL, -- Need M
  dedicatedPosSysInfoDelivery-r16 OCTET STRING (CONTAINING PosSystemIn-
formation-r16-Ies) OPTIONAL, -- Need N
  sl-ConfigDedicatedNR-r16 SetupRelease {SL-ConfigDedicatedNR-r16}
OPTIONAL, -- Need M
  sl-ConfigDedicatedEUTRA-Info-r16 SetupRelease
{SL-ConfigDedicatedEUTRA-Info-r16} OPTIONAL, -- Need M
  targetCellSMTC-SCG-r16 SSB-MTC
  OPTIONAL, -- Need S
  nonCriticalExtension RRCReconfiguration-v1700-Ies
  OPTIONAL
  }
  RRCReconfiguration-v1700-Ies ::= SEQUENCE {
  otherConfig-v1700 OtherConfig-v1700
  OPTIONAL, -- Need M
  sl-L2RelayUE-Config-r17 SetupRelease { SL-L2RelayUE-Config-r17 }
OPTIONAL, -- Need M
  sl-L2RemoteUE-Config-r17 SetupRelease { SL-L2RemoteUE-Config-r17 }
OPTIONAL, -- Need M
  dedicatedPagingDelivery-r17 OCTET STRING (CONTAINING Paging)
OPTIONAL, -- Cond PagingRelay
  needForGapNCSG-ConfigNR-r17 SetupRelease
{NeedForGapNCSG-ConfigNR-r17} OPTIONAL, -- Need M
  needForGapNCSG-ConfigEUTRA-r17 SetupRelease
{NeedForGapNCSG-ConfigEUTRA-r17} OPTIONAL, -- Need M
  musim-GapConfig-r17 SetupRelease {MUSIM-GapConfig-r17} OPTIONAL, --
Need M
  ul-GapFR2-Config-r17 SetupRelease { UL-GapFR2-Config-r17 } OPTIONAL, --
Need M
  scg-State-r17 ENUMERATED { deactivated }
  OPTIONAL, -- Need N
  appLayerMeasConfig-r17 AppLayerMeasConfig-r17
  OPTIONAL, -- Need M
  ue-TxTEG-RequestUL-TDOA-Config-r17 SetupRelease
{UE-TxTEG-RequestUL-TDOA-Config-r17} OPTIONAL, -- Need M
  nonCriticalExtension RRCReconfiguration-v18xy
  OPTIONAL
  }
  RRCReconfiguration-v18xy-Ies ::= SEQUENCE {
  ltm-CandidateConfig-r18 SetupRelease {LTM-CandidateConfig-r18} OPTIONAL, -
- Need M
  nonCriticalExtension SEQUENCE { }
  OPTIONAL
  }
  6.3.2 Radio resource control information elements
  LTM-CandidateConfig
  The IE LTM-CandidateConfig is used to provide LTM candidate cell configuration.
  LTM-CandidateConfig information element
  ASN1START
  TAG-LTM-CANDIDATECONFIG-START
  LTM-CandidateConfig-r18 ::= SEQUENCE {
  Lte-ReferenceConfiguration-r18 OCTET STRING (CONTAINING RRCRecon-
figuration) OPTIONAL, -- Need N
  ltm-CandidateToReleaseList-r18 LTM-CandidateToReleaseList-r18 OPTIONAL, --
Need N
  ltm-CandidateToAddModList-r18 LTM-CandidateToAddModList-r18 OPTIONAL,
-- Need N
  ltm-candidatePartial-L2reset-Sets SEQUENCE (SIZE (1..FFS)) OF LTM-
CandidatePartial-L2reset-Set-18 OPTIONAL ...
  }
  LTM-CandidateToReleaseList-r18 ::= SEQUENCE (SIZE
(1..maxNrofCellsLTM-r18)) OF LTM-CandidateId-r18 OPTIONAL, -- Need N
  LTM-CandidateToAddModList-r18 ::= SEQUENCE (SIZE
(1..maxNrofCellsLTM-r18)) OF LTM-Candidate-r18
  LTM-CandidatePartial-L2reset-Set-18 ::= SEQUENCE (SIZE (1..FFS)) OF LTM-
CandidateId-r18
  LTM-Candidate-r18 ::= SEQUENCE {
  ltm-CandidateId-r18 LTM-CandidateId-r18,
  ltm-Config-r18 OCTET STRING (CONTAINING RRCReconfiguration),
  ...
  }
  TAG-LTM-CANDIDATECONFIG-STOP
  ASN1STOP
```

TABLE 1
LTM-CandidateConfig field descriptions

Itm-ReferenceConfiguration
This field includes an RRCReconfiguration message used to configure a reference
configuration for LTM.
Itm-Config
This field includes an RRCReconfiguration message used to configure an LTM
candidate cell. This field can include only the CellGroupConfig IE, RadioBear-
erConfig IE, and MeasConfig IE.
Itm-candidatePartial-L2reset-Sets
This field indicates the sets of candidate cells in which full L2 reset is not performed
upon LTM cell switch.

The LTM cell switch is supervised by a timer. The timer Tcellswitch is started when the UE receives cell switch command and is stopped once the cell switch is completed (successfully or failed). In an option, the Tcellswitch is defined as a new timer; for example, in NR RRC specification TS 38.331, there may be a new timer T3xx defined. In another option, the NR RRC timer T304 can be used for supervising LTM cell switch and all the embodiments for Tcellswitch are applicable for T304 when it is used for LTM, such as supervising LTM cell switch. The UE arrival in the target cell will be indicated to the network entity by uplink signaling, either MAC signaling or RRC signaling. The cell switch is completed once the UE successfully completes random access for RACH based cell switch. For RACH less cell switch, the cell switch may be completed once a UL transmission is successful (for example, the UL transmission for indicating the in the target cell. In Release 18 NR, the LTM is supported in dual connectivity (i.e., NR-DC) also.

N310 and N311 counters: In 3GPP NR, the UE uses two counters for radio link failure related actions, namely N310 and N311 during RRC_CONNECTED state. The counters N310 and N311 are defined and described in detail in 3GPPTS 38.331. V17.3.0 of TS 38.331 can be considered as relevant background.

The N310 counter counts the consecutive “out-of-sync” indications for the SpCell from lower layers. Upon reception of “out-of-sync” from the lower layer while the timer T310 is stopped, the counter may be reset for different reasons such as receiving in-sync indication or initiating a RRC Reestablishment. When the N310 counter reaches maximum value, the UE starts timer T310.

T310 and the corresponding actions are defined as below:

TABLE 2

| Timer | Start | Stop | At expiry |
|---|---|---|---|
| T310 | Upon detecting | Upon receiving | If the T310 is kept in |
| | physical layer | N311 consecutive | MCG: If AS security |
| | problems for | in-sync indications | is not activated: go |
| | the SpCell i.e. | from lower layers | to RRC_IDLE else: |
| | upon receiving | for the SpCell, upon | initiate the MCG |
| | N310 | receiving RRCRe- | failure information |
| | consecutive | configuration with | procedure as |
| | out-of-sync | reconfigurationWith | specified in 5.7.3b |
| | indications | Sync for that cell | or the connection re- |
| | from lower | group, upon | establishment |
| | layers. | reception of Mobili- | procedure as |
| | | tyFromNRCommand, | specified in 5.3.7 or |
| | | upon the recon- | the procedure as |
| | | figuration of rlf- | specified in 5.3.10.3 |
| | | TimersAndConstant, | if any DAPS bearer |
| | | upon initiating the | is configured. |
| | | connection re- | If the T310 is kept in |
| | | establishment | SCG, Inform E- |
| | | procedure, upon | UTRAN/NR about |
| | | conditional recon- | the SCG radio link |
| | | figuration execution | failure by initiating |
| | | i.e. when applying a | the SCG failure in- |
| | | stored RRCRecon- | formation procedure |
| | | figuration message | as specified in 5.7.3. |
| | | including reconfigu- | |
| | | rationWithSync for | |
| | | that cell group, and | |
| | | upon initiating the | |
| | | MCG failure in- | |
| | | formation procedure. | |
| | | Upon SCG release, | |
| | | if the T310 is kept in | |
| | | SCG. | |

The below specification extracts define the behaviour of counter N310. 5.3.10.1 Detection of physical layer problems in RRC_CONNECTED. The UE shall:
if any DAPS bearer is configured, upon receiving N310 consecutive “out-of-sync” indications for the source SpCell from lower layers and T304 is running:
start timer T310 for the source SpCell.
upon receiving N310 consecutive “out-of-sync” indications for the SpCell from lower layers while neither T300, T301, T304, T311, T316 nor T319 are running:
start timer T310 for the corresponding SpCell.

The N311 counter is used for the recovery from the physical layer problems. The N311 counts the consecutive in-sync indications for the SpCell from the lower layers when the timer T310 is running. Upon reception of the “in-sync” from lower layer while the timer T310 is running, the N311 counter is incremented.

The N311 counter is reset in cases such as upon reception of “out-of-sync” indication from lower layers or initiation of connection reestablishment procedure. When reaching maximum value of N311 counter, the UE stops the timer T310. The below specification extracts define the behaviour of counter N311.

### 5.3.10.2 Recovery of Physical Layer Problems

Upon receiving N311 consecutive “in-sync” indications for the SpCell from lower layers while T310 is running, the UE shall:
stop timer T310 for the corresponding SpCell.
stop timer T312 for the corresponding SpCell, if running.

Maximum number of consecutive “in-sync” indications for the SpCell received from the lower layers.

RRC IE RLF-TimersAndConstants is used by the gNB to configure the UE with the counters n310 and n311.

```
  RLF-TimersAndConstants ::= SEQUENCE {
  t310 ENUMERATED {ms0, ms50, ms100, ms200, ms500, ms1000,
ms2000, ms4000, ms6000},
  n310 ENUMERATED {n1, n2, n3, n4, n6, n8, n10, n20},
  n311 ENUMERATED {n1, n2, n3, n4, n5, n6, n8, n10},
  ...,
  [[
  t311 ENUMERATED {ms1000, ms3000, ms5000, ms10000, ms15000,
ms20000, ms30000}
  ]]
  }
```

The embodiments herein achieve methods for handling a timer of a UE during a LTM scenario in a wireless network. The method includes receiving, by the UE, a LTM configuration including a timer per candidate cell per cell group from a network entity. Further, the method includes receiving, by the UE, a LTM cell switch command from the network entity. Further, the method includes starting, by the UE, the timer for a LTM cell switch in a LTM candidate configuration upon reception of the LTM cell switch command. Further, the method includes performing, by the UE, at least one action upon determining at least one of: an expiry of the timer, stopping the timer, and running the timer.

Unlike conventional methods and systems, unless the cell switch is controlled by the timer (i.e., Tcellswitch), the UE may remain in a deadlock state waiting for the network action for the cell switch and will remain out of service. Expiry actions (either based on 3GPP specifications or UE implementations) of RRC timer(s) such as T310, T312, T304, T350. T320. T321, T390 may interfere with the LTM cell switch execution leading to the LTM cell switch failure or other undesirable actions.

Referring now to the drawings, and more particularly to FIGS. 1 through 10, where similar reference characters denote corresponding features consistently throughout the figures, there are shown at least one embodiment.

FIG. 1 illustrates a wireless network (1000) for handling a timer of a UE (100) during a LTM scenario in the wireless network (1000), according to the embodiments as disclosed herein. In an embodiment, the wireless network (1000) includes the UE (100) and the network entity (200). The wireless network (1000) (1000) can be, for example, but not limited to a fourth generation (4G) network, a fifth generation (5G) network, a 6G network, an Open Radio Access Network (ORAN) or the like.

The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network entity (200) can be, for example, but not limited to a gNB, a eNB, a new radio (NR) trans-receiver or the like.

### Tcellswitch Handling:

Configuration: In an embodiment, the network entity (200) (e.g., gNB) configures the same timer T304 for cell switch supervision. Here, the gNB configures the T304 for L3 mobility and LTM. Though the same timer variable is configured for L3 mobility and cell switch, the values configured for the cell switch and L3 mobility needn't be the same. When the same timer is used, the value ranges could be the same, but gNB can configure different values for L3 mobility and LTM. In another embodiment, a Tcellswitch and T304 are different timers, where the Tcellswitch is defined separately in a 3GPP specifications like technical specification (TS) 38.331.

In an embodiment, the gNB configures Tcellswitch for each candidate cell separately. The Tcellswitch is configured for each cell group. An example specification extract is given below.

```
  CandLTM-ToAddMod ::= SEQUENCE {
  candLTM-ReconfigId CandLTM-ReconfigId,
  candLTM-Reconfig CandLTM-Reconfig,
  }
  CandLTM-Reconfig ::= SEQUENCE {
  candLTM-CellGroupConfig CellGroupConfig,
  measConfig MeasConfig OPTIONAL,
  radioBearerConfig RadioBearerConfig OPTIONAL,
  <other IEs>
  }
  Configuration of one Cell-Group:
  CellGroupConfig ::= SEQUENCE {
  cellGroupId CellGroupId,
  rlc-BearerToAddModList SEQUENCE (SIZE(1..maxLC-ID)) OF RLC-
BearerConfig OPTIONAL, -- Need N
  rlc-BearerToReleaseList SEQUENCE (SIZE(1..maxLC-ID)) OF LogicalChan-
nelIdentity OPTIONAL, -- Need N
  mac-CellGroupConfig MAC-CellGroupConfig
  OPTIONAL, -- Need M
  physicalCellGroupConfig PhysicalCellGroupConfig
  OPTIONAL, -- Need M
  spCellConfig SpCellConfig
  OPTIONAL, -- Need M
  sCellToAddModList SEQUENCE (SIZE (1..maxNrofSCells)) OF SCellConfig
OPTIONAL, -- Need N
  sCellToReleaseList SEQUENCE (SIZE (1..maxNrofSCells)) OF SCellIndex
OPTIONAL, -- Need N
  ...,
  [[
  reportUplinkTxDirectCurrent ENUMERATED {true}
  OPTIONAL -- Cond BWP-Reconfig
  ]],
  [[
  bap-Address-r16 BIT STRING (SIZE (10))
  OPTIONAL, -- Need M
  bh-RLC-ChannelToAddModList-r16 SEQUENCE
(SIZE(1..maxBH-RLC-ChannelID-r16)) OF BH-RLC-ChannelConfig-r16
OPTIONAL, -- Need N
  bh-RLC-ChannelToReleaseList-r16 SEQUENCE
(SIZE(1..maxBH-RLC-ChannelID-r16)) OF BH-RLC-ChannelID-r16 OPTIONAL, --
Need N
  f1c-TransferPath-r16 ENUMERATED {lte, nr, both} OPTIONAL, -- Need M
  simultaneousTCI-UpdateList1-r16 SEQUENCE (SIZE
(1..maxNrofServingCellsTCI-r16)) OF ServCellIndex OPTIONAL, -- Need R
  simultaneousTCI-UpdateList2-r16 SEQUENCE (SIZE
(1..maxNrofServingCellsTCI-r16)) OF ServCellIndex OPTIONAL, -- Need R
  simultaneousSpatial-UpdatedList1-r16 SEQUENCE (SIZE
(1..maxNrofServingCellsTCI-r16)) OF ServCellIndex OPTIONAL, -- Need R
  simultaneousSpatial-UpdatedList2-r16 SEQUENCE (SIZE
(1..maxNrofServingCellsTCI-r16)) OF ServCellIndex OPTIONAL, -- Need R
  uplinkTxSwitchingOption-r16 ENUMERATED {switchedUL, dualUL}
OPTIONAL, -- Need R
  uplinkTxSwitchingPowerBoosting-r16 ENUMERATED {enabled} OPTIONAL --
Need R
  ]],
  [[
  reportUplinkTxDirectCurrentTwoCarrier-r16 ENUMERATED {true} OPTIONAL --
Need N
  ]],
  [[
  f1c-TransferPathNRDC-r17 ENUMERATED {mcg, scg, both} OPTIONAL, -- Need
M
  uplinkTxSwitching-2T-Mode-r17 ENUMERATED {enabled} OPTIONAL, -- Cond
2Tx
  uplinkTxSwitching-DualUL-TxState-r17 ENUMERATED {oneT, twoT}
OPTIONAL, -- Cond 2Tx
  uu-RelayRLC-ChannelToAddModList-r17 SEQUENCE
(SIZE(1..maxUu-RelayRLC-ChannelID-r17)) OF Uu-RelayRLC-ChannelConfig-r17
  OPTIONAL, -- Need N
  uu-RelayRLC-ChannelToReleaseList-r17 SEQUENCE
(SIZE(1..maxUu-RelayRLC-ChannelID-r17)) OF Uu-RelayRLC-ChannelID-r17
  OPTIONAL, -- Need N
  simultaneousU-TCI-UpdateList1-r17 SEQUENCE (SIZE
(1..maxNrofServingCellsTCI-r16)) OF ServCellIndex OPTIONAL, -- Need R
  simultaneousU-TCI-UpdateList2-r17 SEQUENCE (SIZE
(1..maxNrofServingCellsTCI-r16)) OF ServCellIndex OPTIONAL, -- Need R
  simultaneousU-TCI-UpdateList3-r17 SEQUENCE (SIZE
(1..maxNrofServingCellsTCI-r16)) OF ServCellIndex OPTIONAL, -- Need R
  simultaneousU-TCI-UpdateList4-r17 SEQUENCE (SIZE
(1..maxNrofServingCellsTCI-r16)) OF ServCellIndex OPTIONAL, -- Need R
  rlc-BearerToReleaseListExt-r17 SEQUENCE (SIZE(1..maxLC-ID)) OF Logi-
calChannelIdentityExt-r17 OPTIONAL, -- Need N
  iab-ResourceConfigToAddModList-r17 SEQUENCE
(SIZE(1..maxNrofIABResourceConfig-r17)) OF IAB-ResourceConfig-r17
OPTIONAL, -- Need N
  iab-ResourceConfigToReleaseList-r17 SEQUENCE
(SIZE(1..maxNrofIABResourceConfig-r17)) OF IAB-ResourceConfigID-r17
OPTIONAL -- Need N
  ]],
  [[
  reportUplinkTxDirectCurrentMoreCarrier-r17 ReportUplinkTxDirectCurrent-
MoreCarrier-r17 OPTIONAL -- Need N
  ]]
  }
  Serving cell specific MAC and PHY parameters for a SpCell:
  SpCellConfig ::= SEQUENCE {
  servCellIndex ServCellIndex
  OPTIONAL, -- Cond SCG
  reconfigurationWithSync ReconfigurationWithSync OPTIONAL, -- Cond Recon-
fWithSync
  rlf-TimersAndConstants SetupRelease { RLF-TimersAndConstants } OPTIONAL, --
Need M
  rlmInSyncOutOfSyncThreshold ENUMERATED {n1} OPTIONAL, -- Need S
  spCellConfigDedicated ServingCellConfig
  OPTIONAL, -- Need M
  ...,
  }
  ReconfigurationWithSync ::= SEQUENCE {
  spCellConfigCommon ServingCellConfigCommon OPTIONAL, -- Need M
  newUE-Identity RNTI-Value,
  t304 ENUMERATED {ms50, ms100, ms150, ms200, ms500, ms1000, ms2000,
ms10000},
  rach-ConfigDedicated CHOICE {
  uplink RACH-ConfigDedicated,
  supplementaryUplink RACH-ConfigDedicated
  } OPTIONAL, -- Need N
  ...,
  [[
  smtc SSB-MTC OPTIONAL -- Need S
  ]],
  [[
  daps-UplinkPowerConfig-r16 DAPS-UplinkPowerConfig-r16 OPTIONAL -- Need
N
  ]],
  [[
  sl-PathSwitchConfig-r17 SL-PathSwitchConfig-r17
  OPTIONAL -- Cond DirectToIndirect-PathSwitch
  ]],
  [[
  tcellSwitch-r17 ENUMERATED {ms50, ms100, ms150, ms200, ms500, ms 1000,
ms2000, ms10000},
  ]]
  }
```

In an embodiment, the gNB configures the Tcellswitch with a different range of values than T304, for e.g. as given below:

tcellSwitch-r17 ENUMERATED {ms50, ms100, ms150, ms200, ms300, ms500, ms700, ms1000},

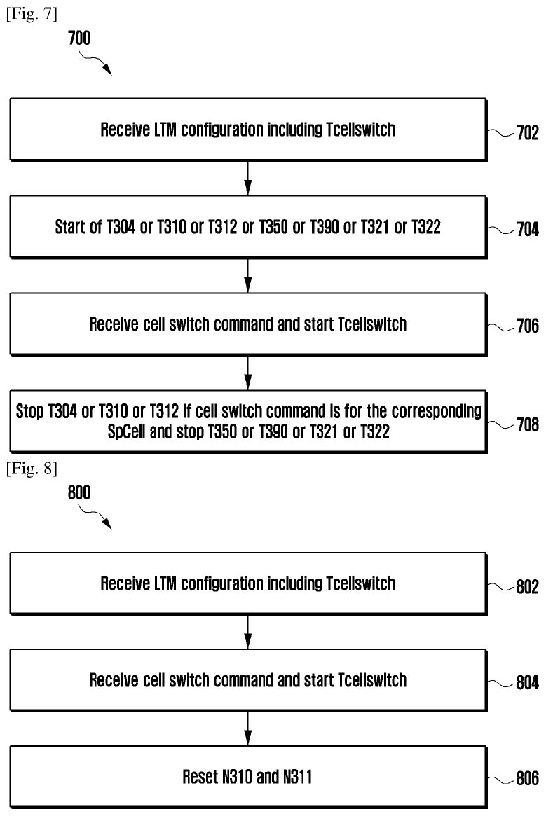

Tcellswitch handling for various events: In an embodiment, the UE (100) starts the Tcellswitch upon receiving a command for the cell switch from the network (such as MAC CE for LTM cell switch). In an embodiment, the Tcellswitch is started upon receiving the MAC CE for the LTM cell switch, if the UE (100) is required to perform random access upon the cell switch. FIG. 7 depicts a process of handling the UE timer during the cell switch.

In an embodiment, the UE (100) stops the timer Tcellswitch upon successful completion of random access on the corresponding Spcell. This could be applicable when the UE (100) is configured to perform random access for LTM completion.

In an embodiment, the UE (100) which is configured for the LTM and is configured for completing LTM without performing random access, stops the timer Tcellswitch upon successfully performing UL transmission; for e.g., the UL transmission to indicate successful completion of LTM.

In an embodiment, the UE (100) stops the timer Tcellswitch for SCG upon SCG release.

In an embodiment, the UE (100) stops the timer Tcellswitch upon SCG layer 3 mobility. In an embodiment, the UE (100) stops the timer Tcellswitch for SCG upon PSCellChange (i.e., RRC Reconfiguration for PSCellChange) received from the network entity (200) and sends RRC Reconfiguration Complete. In an embodiment, the UE (100) may initiate SCGFailureInformation upon stopping the timer due to SCG L3 mobility.

In an alternate embodiment, the UE (100) ignores SCG L3 mobility initiation (i.e., RRC Reconfiguration message or CPAC execution condition satisfaction for SCG) while the Tcellswitch is running.

In an embodiment, the UE (100) stops the timer Tcellswitch for SCG upon MCG layer 3 mobility. In an embodiment, the UE (100) may initiate SCGFailureInformation upon stopping the timer due to MCG L3 mobility.

In an alternate embodiment, the UE (100) ignores MCG L3 mobility initiation (RRC Reconfiguration message or CHO execution condition satisfaction for MCG) while the Tcellswitch for SCG is running.

In an embodiment, the UE (100) stops the timer Tcellswitch for SCG upon any of SCG or MCG layer 3 mobility. In an embodiment, the UE (100) may initiate SCGFailureInformation upon stopping the timer due to SCG or MCG L3 mobility.

In an alternate embodiment, the UE (100) ignores L3 mobility initiation (RRC Reconfiguration message or CHO/CPAC execution condition satisfaction for SCG or MCG), while the Tcellswitch for SCG is running.

In an embodiment, the UE (100) stops the timer Tcellswitch for MCG upon MCG layer 3 mobility. In an alternate embodiment, the UE (100) ignores MCG L3 mobility initiation (RRC Reconfiguration message or CHO execution condition satisfaction for MCG) while the Tcellswitch for MCG is running.

In an embodiment, the UE (100) stops the timer Tcellswitch for MCG upon any of SCG or MCG layer 3 mobility. In an alternate embodiment, the UE (100) ignores L3 mobility initiation (RRC Reconfiguration message or CHO execution condition satisfaction for MCG or SCG) while the Tcellswitch for MCG is running.

In an embodiment, the UE (100) stops Tcellswitch upon receiving a RRC message (such as RRC Reconfiguration) modifying LTM configuration. In an embodiment, the UE (100) stops Tcellswitch upon receiving a RRC message (such as RRC Reconfiguration) modifying LTM configuration or the candidate cell configuration for the candidate cell to which the UE (100) is performing cell switch. In an embodiment, the UE (100) stops the Tcellswitch upon receiving the RRC message (such as RRC Reconfiguration) modifying or releasing LTM reference configuration (applied for the candidate cell; for e.g., when candidate cell configuration is not configured as full configuration).

In an alternative embodiment, the UE (100) ignores RRC message (such as RRC Reconfiguration) upon one or more conditions like modifying or releasing LTM configuration, modifying or releasing LTM configuration of the candidate cell to which the UE (100) is performing cell switch, modifying or releasing the candidate cell configuration for the candidate cell to which the UE (100) is performing cell switch or modifying or releasing LTM reference configuration (applied for the candidate cell, for e.g. when candidate cell configuration is not configured as full configuration), while Tcellswitch is running. The gNB may retransmit this RRC message (including modifying the RRC message and retransmit) after the cell switch execution is completed successfully. Alternatively, gNB may decide to drop the RRC message.

In an embodiment, the UE (100) ignores any RRC message received while Tcellswitch is running. In an embodiment, the UE (100) ignores the RRC Reconfiguration message received while the Tcellswitch is running. In an embodiment, this ignoring is performed for the RRC messages for the cell group where the Tcellswitch is running. For the SCG, in a specific case, even when the Tcellswitch for the MCG is running, the UE (100) ignores the RRC message. The gNB may retransmit this RRC message (including modifying the RRC message and retransmit) after the cell switch execution is completed successfully. Alternatively, the gNB may decide to drop the RRC message.

In an embodiment, the UE (100) stops the Tcellswitch upon receiving the RRC message. In an embodiment, the UE (100) stops the Tcellswitch upon receiving the RRC Reconfiguration message. The UE (100) skips sending indication for LTM Completion.

In an embodiment, the UE (100) stops the Tcellswitch for the SCG upon receiving the RRC message (such as RRC Reconfiguration) modifying LTM configuration. In an embodiment, the UE (100) stops the Tcellswitch for the SCG upon receiving the RRC message (such as RRC Reconfiguration) modifying LTM configuration or the candidate cell configuration for the candidate cell to which the UE (100) is performing cell switch. In an embodiment, the UE (100) stops the Tcellswitch for SCG upon receiving the RRC message (such as RRC Reconfiguration) modifying or releasing LTM reference configuration (applied for the candidate cell, (for example) when candidate cell configuration is not configured as full configuration). The UE (100) skips sending indication for LTM completion.

In an alternative embodiment, the UE (100) ignores the RRC message (such as RRC Reconfiguration) or the CPAC execution condition satisfaction for the SCG, for one or more operations like modifying or releasing LTM configuration, modifying or releasing the LTM configuration of the candidate cell to which the UE (100) is performing cell switch, modifying or releasing the candidate cell configuration for the candidate cell to which the UE (100) is performing cell switch or modifying or releasing LTM reference configuration (applied for the candidate cell, for e.g. when candidate cell configuration is not configured as full configuration) for SCG, while the Tcellswitch is running.

In an alternative embodiment, the UE (100) ignores the RRC message (such as RRC Reconfiguration) or the CPAC execution condition satisfaction for the SCG, for one or more operations like modifying or releasing LTM configuration, modifying or releasing LTM configuration of the candidate cell to which the UE (100) is performing the cell switch, modifying or releasing the candidate cell configuration for the candidate cell to which the UE (100) is performing cell switch or modifying or releasing LTM reference configuration (applied for the candidate cell, for e.g. when candidate cell configuration is not configured as full configuration) for one of the SCG or the MCG, while the Tcellswitch is running.

In an embodiment, the UE (100) stops the Tcellswitch for the MCG upon receiving the RRC message (such as RRC Reconfiguration) modifying the LTM configuration. In an embodiment, the UE (100) stops the Tcellswitch for the MCG upon receiving the RRC message (such as RRC Reconfiguration) modifying LTM configuration or the candidate cell configuration for the candidate cell to which the UE (100) is performing cell switch.

In an alternative embodiment, the UE (100) ignores the RRC message (such as RRC Reconfiguration) or the CPAC execution condition satisfaction for the MCG, upon one or more conditions like modifying or releasing LTM configuration, modifying or releasing the LTM configuration of the candidate cell to which the UE (100) is performing cell switch, modifying or releasing the candidate cell configuration for the candidate cell to which the UE (100) is performing cell switch or modifying or releasing LTM reference configuration (applied for the candidate cell, for e.g. when candidate cell configuration is not configured as full configuration) for MCG, while the Tcellswitch is running.

In an alternative embodiment, the UE (100) ignores RRC message (such as RRC Reconfiguration) or the CPAC execution condition satisfaction for the MCG, upon one or more conditions like modifying or releasing LTM configuration, modifying or releasing LTM configuration of the candidate cell to which the UE (100) is performing cell switch, modifying or releasing the candidate cell configuration for the candidate cell to which the UE (100) is performing cell switch or modifying or releasing LTM reference configuration (applied for the candidate cell, for e.g. when candidate cell configuration is not configured as full configuration) for the MCG or the SCG, while the Tcellswitch is running.

In an embodiment, the UE (100) stops the Tcellswitch upon receiving the RRC message (such as RRC Reconfiguration) releasing LTM configuration. In an embodiment, the UE (100) stops the Tcellswitch upon receiving the RRC message (such as RRC Reconfiguration) releasing LTM configuration or the candidate cell configuration for the candidate cell to which the UE (100) is performing the cell switch. The UE (100) skips sending indication for LTM completion.

In an embodiment, the UE (100) stops the Tcellswitch for SCG upon receiving the RRC message (such as RRC Reconfiguration) releasing the LTM configuration. In an embodiment, the UE (100) stops the Tcellswitch for the SCG upon receiving the RRC message (such as RRC Reconfiguration) releasing LTM configuration or the candidate cell configuration for the candidate cell to which the UE (100) is performing cell switch.

In an embodiment, the UE (100) stops the Tcellswitch for the MCG upon receiving the RRC message (such as RRC Reconfiguration) releasing the LTM configuration. In an embodiment, the UE (100) stops the Tcellswitch for the MCG upon receiving the RRC message (such as RRC Reconfiguration) releasing LTM configuration or the candidate cell configuration for the candidate cell to which the UE (100) is performing the cell switch.

In an embodiment, the UE (100) stops the Tcellswitch upon receiving the RRC message (such as RRC Reconfiguration) releasing the LTM configuration. In an embodiment, the UE (100) stops the Tcellswitch upon receiving the RRC message (such as RRC Reconfiguration) releasing LTM configuration or the candidate cell configuration for the candidate cell to which the UE (100) is performing cell switch.

In an embodiment, the UE (100) stops the Tcellswitch upon security key update. In an embodiment, the UE (100) stops the Tcellswitch for the SCG upon the security key update. In an embodiment, the UE (100) stops the Tcellswitch for the MCG upon the security key update.

In an embodiment, the UE (100) stops the Tcellswitch upon receiving the RRC message (such as RRC Reconfiguration) including masterKeyUpdate or SN counter (e.g., sk-counter).

In an embodiment, the UE (100) stops the Tcellswitch for the SCG upon receiving the RRC message (such as RRC Reconfiguration) including the masterKeyUpdate or the SN counter (e.g., sk-counter). In an embodiment, the UE (100) stops the Tcellswitch for the MCG upon receiving the RRC message (such as RRC Reconfiguration) including the masterKeyUpdate.

In an embodiment, the UE (100) ignores the security key update while the Tcellswitch is running. In an embodiment, the UE (100) ignores the security key update for the SCG while the Tcellswitch is running. In an embodiment, the UE (100) ignores the security key update for the MCG while the Tcellswitch is running.

In an embodiment, the UE (100) stops the Tcellswitch upon receiving MobilityFromNRCommand from the network entity (200).

In an embodiment, if the UE (100) stops the Tcellswitch except for successful completion, the UE (100) skips sending indication to the network entity (200) for LTM completion. In an embodiment, if the UE (100) stops the Tcellswitch for the SCG except for successful completion, the UE (100) may send SCGFailureInformation.

In an embodiment, if the UE (100) stops the Tcellswitch for the MCG except for successful completion, the UE (100) may send RRC Reestablishment or MCGFailureInformation (perform RRCReestablishment procedure or fast MCG recovery).

In an embodiment, if the UE (100) ignores the RRC message due to the Tcellswitch running, the UE (100) skips sending the RRC completion message to the network entity (200). In an embodiment, the UE (100) may send SCGFailureInformation (for SCG) or RRCReestablishment/MCGFailureInformation (for MCG).

In an embodiment, the UE (100) queues the RRC message received while the Tcellswitch is running and processes the same after the Tcellswitch is stopped (i.e. after LTM cell switch execution is completed). In an embodiment, the UE ignores the RRC message received while the Tcellswitch is running if RRC IEs for cell group configuration such as CellGroupConfig is included in the RRC message (and avoids sending the RRC Reconfiguration Complete) and queues the RRC message if those IEs are not included (and processes the RRC message after LTM cell switch is completed and sends RRC Reconfiguration Complete). In an embodiment, the UE ignores the RRC message received while the Tcellswitch is running if RRC IEs for security configuration is included in the RRC message (and avoids sending the RRC Reconfiguration Complete) and queues the RRC message if those IEs are not included (and processes the RRC message after LTM cell switch is completed and sends RRC Reconfiguration Complete). The UE (100) ignores the RRC message received while the Tcellswitch is running if RRC IEs for secondary cell group configuration are included in the RRC message (and avoids sending the RRC Reconfiguration Complete) and queues the RRC message if those IEs are not included (and processes the RRC message after LTM cell switch is completed and sends RRC Reconfiguration Complete).

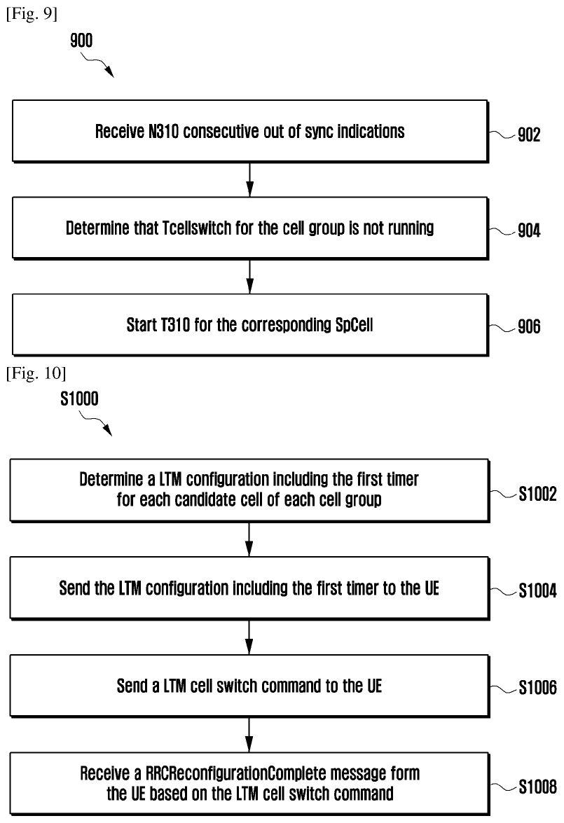

In an embodiment, upon reception of RRCRelease, the UE (100) stops the timer Tcellswitch. FIG. 9 depicts a process of starting and stopping the Tcellswitch.

In an embodiment, upon expiry of the Tcellswitch, the UE (100) sends the RRCReestablishment or MCGFailureInformation for the MCG (if Tcellswitch expiry is for the MCG) and SCGFailureInformation for the SCG (if Tcellswitch expiry is for SCG) to the network entity (200). FIG. 6 depicts the scenario, where the Tcellswitch has expired.

T304 handling: In an embodiment, the UE (100) stops the T304 (such as T304 running due to L3 mobility) upon receiving LTM cell switch command. In an embodiment, the UE (100) stops the T304 for the SCG upon receiving LTM cell switch command for the SCG. In an embodiment, the UE (100) stops the T304 (such as T304 running due to L3 mobility) for the SCG upon receiving the LTM cell switch command for at least one of the SCG and the MCG. In an embodiment, the UE (100) stops the T304 (such as T304 running due to L3 mobility) for the MCG upon receiving the LTM cell switch command for MCG. In a specific embodiment, the stopping is performed if the T304 is started due to condition for CHO/CPAC is satisfied.

Alternatively, the UE (100) ignores the LTM cell switch command while the T304 (such as T304 running due to L3 mobility) is running. In an embodiment, this ignoring is performed for the LTM cell switch for the cell group where the T304 is running. For the SCG, in a specific case, even when T304 for MCG is running, the UE (100) ignores LTM cell switch for SCG.

In an embodiment, the UE (100) stops the T304 timer (such as T304 running due to L3 mobility) upon modifying or releasing the configuration of conditional reconfiguration of the candidate cell where the UE (100) is moving to (i.e., the target cell to which UE (100) is performing CHO/CPAC).

In an embodiment, the UE (100) which has received RRCReconfiguration including reconfigurationwithsync for PSCellChange or MCG handover stops T304 started for the CPC. The UE (100) may initiate SCGFailureInformation to the network entity (200) in an option.

In an embodiment, the UE (100) which has received RRCReconfiguration including the conditional reconfiguration to modify or release the candidate SpCell to which the conditional handover or conditional PSCellChange or conditional PSCell Addition is ongoing, stops T304 started for CHO or CPC or CPA. The UE (100) may initiate the SCGFailureInformation (for CPAC) or RRC Reestablishment Request/MCGFailureInformation (for CHO) to the network entity (200) in an option.

T321/T322 handling: In an embodiment, upon receiving cell switch command, the UE (100) stops the periodical reporting timer, timer T321 or timer T322, if running (as defined or described in TS 38.331 v17.2.0).

T350 handling: In an embodiment, upon receiving cell switch command, the UE (100) stops the timer T350, if running (T350 is defined/described in TS 38.331).

T310/T312 handling: In an embodiment, upon receiving cell switch command (in the corresponding SpCell), the UE (100) stops the timer T310/T312, if running (T310/T312 is defined/described in TS 38.331).

T390 handling: In an embodiment, upon receiving cell switch command, the UE (100) stops the timer T390, if running (T390 is defined or described in TS 38.331) for all access categories. In a specific embodiment, this is applied only for cell switch command for MCG.

An example specification changes in TS 38.331 with reference to v17.2.0 is given as below:

TABLE 3

| | | | |
|---|---|---|---|
| T390 | When access | Upon cell | Perform the actions |
| | attempt is barred at | (re)selection, upon | as specified in |
| | access barring check | relay (re)selection, | 5.3.14.4. |
| | for an Access | upon entering | |
| | Category. The UE | RRC_CONNECTED, | |
| | maintains one | upon reception of | |
| | instance of this | RRCReconfiguration | |
| | timer per Access | including recon- | |
| | Category. | figuration WithSync, | |
| | | upon change of | |
| | | PCell while in | |
| | | RRC_CONNECTED, | |
| | | upon reception of | |
| | | MobilityFromNRCom- | |
| | | mand, upon | |
| | | reception of | |
| | | RRCRelease or | |
| | | upon reception of | |
| | | cell switch command. | |

In an embodiment, the wireless network (1000) can be used for handling the LTM in New Radio (NR). Embodiments herein disclose methods and wireless network (100) for detection of physical layer problems and recovery from physical layer problems in RRC_CONNECTED. Embodiments herein disclose methods and wireless network for handling various counters such as N310 and N311 during cell switch. Embodiments herein disclose handling of independent counter (COUNT) for each radio bearer during cell switch and configuring the cell switch timer.

In an embodiment, upon receiving the cell switch command, the UE (100) resets the counter N310. The N310 counter and the reset of N310 is as defined in TS 38.331 v17.3.0. In another embodiment, upon receiving the cell switch command for that cell group, the UE (100) resets the counter N310. N310 counter and the reset of N310 is as defined in TS 38.331 v17.3.0. That is, if the UE (100) receives the cell switch command for the MCG, the UE (100) resets the counter for the MCG and if the UE (100) receives the cell switch command for the SCG, the UE (100) resets that counter for the SCG.

In an embodiment, upon receiving the cell switch command, the UE (100) restarts the counter N310 by setting the value of counter N310 to zero. The UE (100) restarts the detection of physical layer problems upon receiving cell switch command.

In an embodiment, upon receiving cell switch command, the UE (100) resets the counter N311. N311 counter and the reset of N311 is as defined in TS 38.331. FIG. 8 depicts the process of handling N310 and N311 counters during the LTM.

In an embodiment, upon receiving cell switch command for that cell group, the UE (100) resets the counter N311. The N311 counter and the reset of N310 is as defined in TS 38.331. If the UE (100) receives cell switch command for the MCG, the UE (100) resets the counter for the MCG. If the UE (100) receives the cell switch command for the SCG, the UE (100) resets that counter for the SCG.

In an embodiment, upon receiving the cell switch command, the UE (100) restarts the counter N311 by setting the value of counter N311 to zero. This ensures that the procedure for recovery from physical layer problems does not start from an incorrect state. FIG. 9 depicts a process of detecting problems with the physical layers.

The above embodiments can lead to the below changes in TS 38.331. Embodiments herein refer to the currently available version TS 38.331 v17.3.0.

### Counters:

TABLE 4

| | | | When reaching |
|---|---|---|---|
| Counter | Reset | Incremented | max value |
| N310 | Upon reception of | Upon reception of | Start timer T310 |
| | “in-sync” indication | “out-of-sync” from | |
| | from lower layers; | lower layer while | |
| | upon receiving | the timer T310 is | |
| | RRCReconfiguration | stopped. | |
| | with reconfigura- | | |
| | tionWithSync for | | |
| | that cell group; upon | | |
| | receiving cell switch | | |
| | command for that | | |
| | cell group; | | |
| | upon initiating the | | |
| | connection re- | | |
| | establishment | | |
| | procedure. | | |
| N311 | Upon reception of | Upon reception of | Stop the timer |
| | out-of-sync” in- | the “in-sync” from | T310. |
| | dication from lower | lower layer while | |
| | layers; | the timer T310 is | |
| | upon receiving | running. | |
| | RRCReconfiguration | | |
| | with reconfigura- | | |
| | tionWithSync for | | |
| | that cell group; upon | | |
| | receiving cell switch | | |
| | command for that | | |
| | cell group; | | |
| | upon initiating the | | |
| | connection re- | | |
| | establishment | | |
| | procedure. | | |

Further the embodiments will lead to the below changes in the specification:

5.x.x.x LTM Cell Switch handling: Upon receiving the indication that LTM cell switch command was received from the lower layers.

reset the counters N310 and N311.

In an embodiment, upon receiving N310 consecutive “out-of-sync” indications for the source SpCell from lower layers, the UE (100) checks if the Tcellswitch is running and skips starting the timer T310 if the Tcellswitch is running. Upon receiving N310 consecutive “out-of-sync” indications for the SpCell from lower layers, while the Tcellswitch is not running, the UE (100) skips starting timer T310 for the corresponding SpCell.

The above embodiments can lead to the below changes in TS 38.331. Refer to the currently available version TS 38.331 v17.3.0.

### 5.3.10.1 Detection of Physical Layer Problems in RRC_CONNECTED

The UE (100) shall:
if any DAPS bearer is configured, upon receiving N310 consecutive “out-of-sync” indications for the source SpCell from lower layers and neither T304 nor Tcellswitch are running:
start timer T310 for the source SpCell.
upon receiving N310 consecutive “out-of-sync” indications for the SpCell from lower layers while neither T300, T301, T304, T311, T316, Tcellswitch nor T319 are running:
start timer T310 for the corresponding SpCell.

Handling of independent counter COUNT for radio bearer during cell switch: In the NR, for each radio bearer, an independent counter (COUNT, as specified in TS 38.323) is maintained for each direction. In an embodiment, the UE (100) does not reset COUNT during cell switch. Upon receiving the cell switch command, the UE (100) maintains the current value of the counter COUNT.

Configuration of Tcellswitch: In an embodiment, TcellSwitch can be set as 0 ms when the UE (100) is not required to perform random access during the cell switch.

In an embodiment, the Tcellswitch is provided to the UE (100) in LTM candidate cell configuration as an optional IE within the LTM-Candidate configuration.

With respect to the example SEQUENCE given in the above (detailed description), the definition could be as below.

```
  LTM-Candidate-r18 ::= SEQUENCE {
  ltm-CandidateId-r18 LTM-CandidateId-r18,
  ltm-Config-r18 OCTET STRING (CONTAINING RRCReconfiguration),
  tcellSwitch ENUMERATED {ms0, ms50, ms100, ms150, ms200, ms500, ms1000,
ms2000, ms10000} OPTIONAL - Need N,
  ...
  }
```

In an embodiment, the Tcellswitch is provided to the UE (100) in LTM candidate cell configuration as an optional IE within the RRC Reconfiguration outside LTM-Candidate configuration. With respect to the example SEQUENCE given in the above (detailed description), the definition could be as below.

```
  RRCReconfiguration-v18xy-Ies ::= SEQUENCE {
  ltm-CandidateConfig-r18 SetupRelease {LTM-CandidateConfig-r18} OPTIONAL, -
- Need M
  tcellSwitch ENUMERATED {ms0, ms50, ms100, ms150, ms200, ms500, ms1000,
ms2000, ms10000} OPTIONAL - Need N,
  nonCriticalExtension SEQUENCE { }
  OPTIONAL
  }
```

In an embodiment, the tcellSwitch has Need code as Need M (as defined in TS 38.331). In an embodiment, tcellSwitch has Need code as Need R.

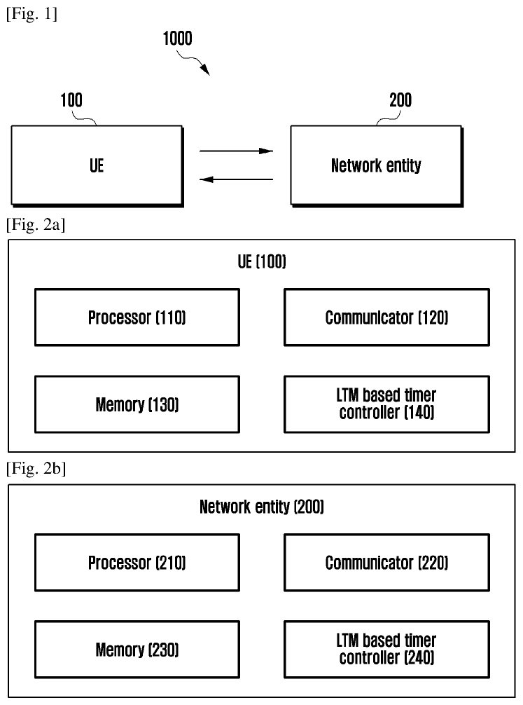

FIG. 2a shows various hardware components of the UE (100), according to the embodiments as disclosed herein. In an embodiment, the UE (100) includes a processor (110), a communicator (120), a memory (130) and a LTM based timer controller (140). The processor (110) is coupled with the communicator (120), the memory (130) and the LTM based timer controller (140).

In an embodiment, the LTM based timer controller (140) receives the LTM configuration including the first timer per candidate cell per cell group from a network entity (200). In an embodiment, the timer is the Tcellswitch, where the timer is configured for each cell group and at least one possible value of the Tcellswitch is ms50, ms100, ms150, ms200, ms500, ms1000, ms2000, and ms10000. Further, the LTM based timer controller (140) receives the LTM cell switch command from the network entity (200). Further, the LTM based timer controller (140) starts the timer for the LTM cell switch in the LTM candidate configuration upon reception of the LTM cell switch command. Further, the LTM based timer controller (140) performs at least one action upon determining at least one of: the expiry of the timer, stopping the timer and running the timer.

In an embodiment, the at least one action includes at least one of: stopping the timer upon successful completion of random access on a corresponding Spcell, stopping the timer upon successfully performing UL transmission to indicate successful completion of the LTM when the LTM is performed without random access, stopping the timer upon the SCG layer 3 mobility, stopping the timer for the MCG upon performing the MCG layer 3 mobility, stopping the timer upon receiving the RRC message modifying LTM configuration, stopping the timer upon receiving the RRC message modifying the candidate cell configuration for the candidate cell to which the UE (100) is performing the LTM cell switch, stopping the timer upon receiving the RRC message modifying or releasing LTM reference configuration, stopping the timer upon at least one of the security key update, the SCG upon security key update and the MCG upon security key update, stopping the timer upon receiving the RRC message including at least one of the masterKeyUpdate and SN counter, stopping the timer for one of: the SCG and MCG upon receiving the RRC message including at least one of the masterKeyUpdate and the SN counter, stopping the timer upon receiving the MobilityFromNRCommand from the network entity (200), stopping the timer upon reception of RRCRelease, and stopping the timer for the SCG upon SCG release.

In an embodiment, the at least one action includes at least one of ignoring the SCG L3 mobility initiation while the timer is running, ignoring the MCG L3 mobility initiation while the timer for one of: the SCG and the MCG is running, ignoring at least one of the security key update, the security key update for SCG and the security key update for MCG while the timer is running, ignoring the RRC message upon determining at least one of: modifying LTM configuration or releasing LTM configuration of the candidate cell to which the UE (100) is performing the cell switch, modifying or releasing the candidate cell configuration for the candidate cell to which the UE (100) is performing cell switch or modifying or releasing LTM reference configuration, while the timer is running, and ignoring the RRC message for the CPAC execution condition satisfaction for one of: the SCG and the MCG, while the timer is running.

In an embodiment, the at least one action includes at least one of sending at least one of: the RRCReestablishment and MCGFailureInformation for the MCG to the network entity (200) upon determining that timer is expired for MCG, and sending the SCGFailureInformation for the SCG upon determining the timer is expired for SCG.

In another embodiment, the LTM based timer controller (140) receives the LTM configuration including the first timer from the network entity (200). Further, the LTM based timer controller (140) starts a second timer. Alternatively, the LTM based timer controller (140) starts the second timer. Further, the LTM based timer controller (140) receives the LTM configuration including the first timer from the network entity (200). In an embodiment, the second timer can be, for example, but not limited to a T310, a T312, a T350, a T390, a T321, and a T322. Further, the LTM based timer controller (140) receives the LTM cell switch command from the network entity (200). Further, the LTM based timer controller (140) starts the first timer for the LTM cell switch based on the LTM cell switch command. In an embodiment, the LTM based timer controller (140) stops the second timer upon determining that the LTM cell switch command is for the corresponding SpCell. The UE (100) may perform the steps for stopping the second timer after receiving the cell switch either before executing cell switch command, along with the various steps for the execution of cell switch command after the successful completion of cell switch command. In another embodiment, the LTM based timer controller (140) performs at least one of: restarts the counter N310 by setting the value of counter N310 to zero and resets the counter N311 upon determining that the LTM cell switch command is for the corresponding SpCell. In an embodiment, the UE (100) restarts the detection of physical layer problems upon receiving the cell switch command.

The LTM based timer controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the user equipment (100) and with external devices via one or more networks.

Although the FIG. 2a shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 2b shows various hardware components of the network entity (200), according to the embodiments as disclosed herein. In an embodiment, the network entity (200) includes a processor (210), a communicator (220), a memory (230) and a LTM based timer controller (240). The processor (210) is coupled with the communicator (220), the memory (230) and the LTM based timer controller (240).

The LTM based timer controller (240) determines the LTM configuration including the first timer for each candidate cell of each cell group. Further, the LTM based timer controller (240) sends the LTM configuration including the first timer to the UE 100. Further, the LTM based timer controller (240) sends the LTM cell switch command to the UE (100). Further, the LTM based timer controller (240) receives the RRCReconfigurationComplete message form the UE (100) based on the LTM cell switch command.

The LTM based timer controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

In an embodiment, the communicator (220) includes an electronic circuit specific to a standard that enables wired or wireless communication. The communicator (220) is configured to communicate internally between internal hardware components of the user equipment (100) and with external devices via one or more networks.

Although the FIG. 2b shows various hardware components of the network entity (200) but it is to be understood that other embodiments are not limited thereon. In other embodiments, the network entity (200) may include less or more number of components. Further, the labels or names of the components are used only for illustrative purpose and does not limit the scope of the invention. One or more components can be combined together to perform same or substantially similar function in the network entity (200).

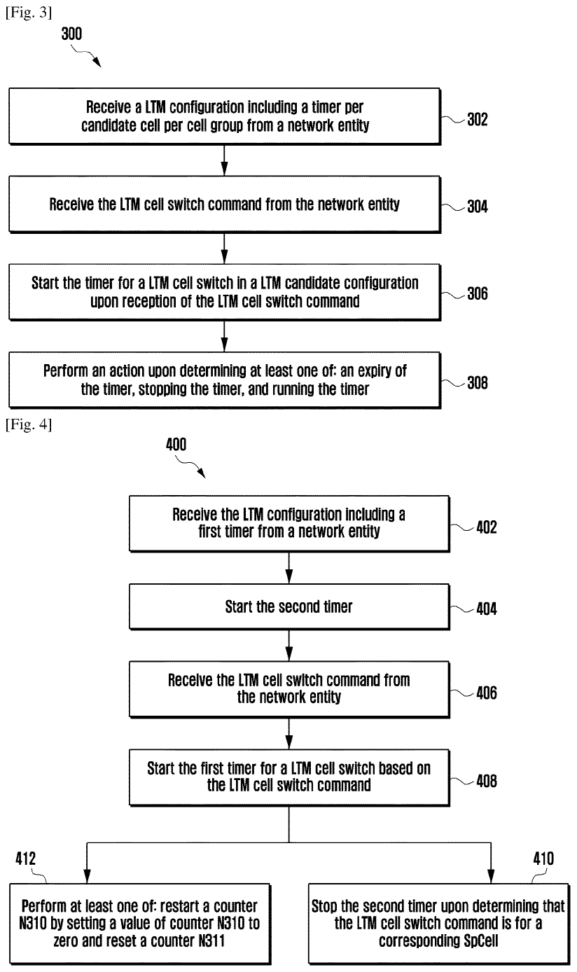

FIG. 3 and FIG. 4 are flow charts (300 and 400) illustrating a method, implemented by the UE (100), for handling the timer of the UE (100) during the LTM scenario in the wireless network (1000), according to the embodiments as disclosed herein.

As shown in FIG. 3, the operations (302-308) are handled by the controller (140). At 302, the method includes receiving the LTM configuration including the timer per candidate cell per cell group from the network entity (200). At 304, the method includes receiving the LTM cell switch command from the network entity (200). At 306, the method includes starting the timer for the LTM cell switch in the LTM candidate configuration upon reception of the LTM cell switch command. At 308, the method includes performing the action upon determining at least one of: the expiry of the timer, stopping the timer, and running the timer. The information related to the action is explained in the FIG. 2.

As shown in FIG. 4, the operations (402-412) are handled by the LTM based timer controller (140). At 402, the method includes receiving the LTM configuration including the first timer from the network entity (200). At 404, the method includes starting the second timer. At 406, the method includes receiving the LTM cell switch command from the network entity (200). At 408, the method includes starting the first timer for the LTM cell switch based on the LTM cell switch command. In an embodiment, at 410, the method includes stopping the second timer upon determining that the LTM cell switch command is for the corresponding SpCell. The UE (100) may perform the steps for stopping the second timer after receiving the cell switch, before executing cell switch command, along with the various steps for the execution of cell switch command or after the successful completion of cell switch command. In another embodiment, at 412, the method includes performing at least one of: restarting the counter N310 by setting the value of counter N310 to zero and resetting the counter N311 upon determining that the LTM cell switch command is for a corresponding SpCell.

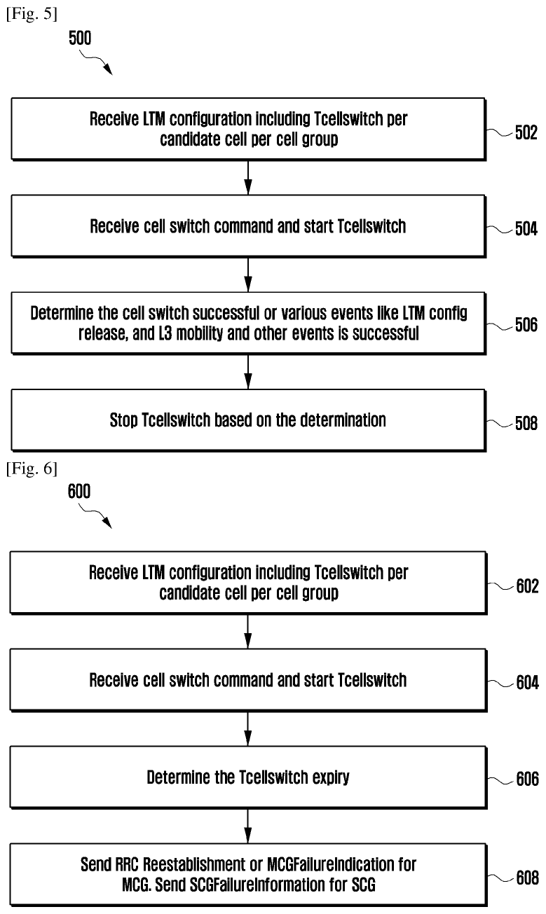

FIG. 5 is a flow chart (500) depicting a process of starting and stopping the Tcellswitch, according to embodiments as disclosed herein. The operations (502-508) are handled by the LTM based timer controller (140).

At 502, the method includes receiving the LTM configuration including the Tcellswitch per candidate cell per cell group. At 504, the method includes receiving the cell switch command and starting the Tcellswitch. At 506, the method includes determining that cell switch is successful or various events like LTM config release, L3 mobility and other events is successful. At 508, the method includes stopping the Tcellswitch based on the determination.

FIG. 6 is a flow chart (600) depicting the scenario, where the Tcellswitch has expired, according to embodiments as disclosed herein. The operations (602-608) are handled by the LTM based timer controller (140).

At 602, the method includes receiving the LTM configuration including Tcellswitch per candidate cell per cell group. At 604, the method includes receiving the cell switch command and starting Tcellswitch. At 606, the method includes determining the Tcellswitch expiry. At 608, the method includes sending the RRC Reestablishment or the MCGFailureIndication for MCG. The method includes sending the SCGFailureInformation for the SCG.

FIG. 7 is a flow chart (700) depicting a process of handling the UE timer during the cell switch, according to embodiments as disclosed herein. The operations (702-708) are handled by the LTM based timer controller (140).

At 702, the method includes receiving the LTM configuration including the Tcellswitch. At 704, the method includes starting of T304 or T310 or T312 or T350 or T390 or T321 or T322. At 706, the method includes receiving the cell switch command and starting the Tcellswitch. At 708, the method includes stopping the T304 or T310 or T312 if the cell switch command is for the corresponding SpCell. The method includes stopping the T350 or T390 or T321 or T322.

FIG. 8 is a flow chart (800) depicting the process of handling N310 and N311 counters during LTM, according to embodiments as disclosed herein. The operations (802-806) are handled by the LTM based timer controller (140).

At 802, the method includes receiving the LTM configuration including Tcellswitch. At 804, the method includes receiving the cell switch command and starting the Tcellswitch At 806, the method includes resetting the N310 and N311.

FIG. 9 is a flow chart (900) depicting a process of detecting problems with the physical layers, according to embodiments as disclosed herein. The operations (902-906) are handled by the LTM based timer controller (140).

At 902, the method includes receiving the N310 consecutive out of sync indications. At 904, the method includes determining that Tcellswitch for the cell group is not running. At 906, the method includes starting the T310 for the corresponding SpCell.

FIG. 10 is a flow chart (S1000) illustrating a method, implemented by the network entity (200b), for handling the timer of the UE (100) during the LTM scenario in the wireless network (1000), according to the embodiments as disclosed herein. The operations (S1002-S1008) are handled by the LTM based timer controller (240).

At S1002, the method includes determining the LTM configuration including the first timer for each candidate cell of each cell group. At S1004, the method includes sending the LTM configuration including the first timer to the UE (100). At S1006, the method includes sending the LTM cell switch command to the UE (100). At S1008, the method includes receiving the RRCReconfigurationComplete message form the UE (100) based on the LTM cell switch command.

The various actions, acts, blocks, steps, or the like in the flow charts (300-900 and S1000) may be performed in the order presented, in a different order or simultaneously. Further, in some embodiments, some of the actions, acts, blocks, steps, or the like may be omitted, added, modified, skipped, or the like without departing from the scope of the invention.

Embodiments as disclosed herein can be equivalently applicable for any timer with an equivalent functionality in any wireless technology.

Embodiments herein have been explained using 5G and associated modules (gNB, NR, UE), however, it may be obvious to a person of ordinary skill in the art that embodiments herein can be extended to any network/technology (6G, and so on) and associated components (i.e., gNB can be any network node, and the UE can be of any technology/network and so on).

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1-15. (canceled)

16. A method by a user equipment (UE) in a wireless communication system, the method comprising:
receiving, from a base station, a control message including a layer 1/layer 2 triggered mobility (LTM) configuration comprising a timer per candidate cell per cell group;
receiving, from the base station, an LTM cell switch command; and
starting the timer for an LTM cell switch in the LTM configuration upon reception of the LTM cell switch command.

17. The method of claim 16, the method further comprising;
in case that a radio resource control (RRC) reconfiguration message is applied due to an LTM cell switch execution without performing a random access procedure and the LTM cell switch is successfully completed, stopping the timer; or
in case that a random access procedure is completed, stopping the timer.

18. The method of claim 16, further comprising:
in case that the timer of a master cell group (MCG) expires, initiating a radio resource control (RRC) reestablishment procedure; or
in case that the timer of a secondary cell group (SCG) expires, transmitting SCG failure information.

19. The method of claim 16,
wherein the timer includes a T304, and
wherein the T304 is configured for each candidate cell in each cell group and at least one possible value of the T304 is ms50, ms100, ms150, ms200, ms500, ms1000, ms2000, and ms10000.

20. The method of claim 16,
wherein the timer of a secondary cell group (SCG) is stopped, upon an SCG release, and
wherein, in case that the LTM cell switch command is received, at least one of a T310 for a source special cell (SpCell), a T312 for the source SpCell, or a T390 for all access categories is stopped.

21. A method by a base station in a wireless communication system, the method comprising:
transmitting, to user equipment (UE), a control message including a layer 1/layer 2 triggered mobility (LTM) configuration comprising a timer per candidate cell per cell group; and
transmitting, to the UE, an LTM cell switch command;
wherein the timer for an LTM cell switch in the LTM configuration is started upon reception of the LTM cell switch command.

22. The method of claim 21,
wherein, in case that a radio resource control (RRC) reconfiguration message is applied due to an LTM cell switch execution without performing a random access procedure and the LTM cell switch is successfully completed, the timer is stopped; or
in case that a random access procedure is completed, the timer is stopped.

23. The method of claim 21, further comprising:
in case that the timer of a master cell group (MCG) expires, receiving, from the UE, a radio resource control (RRC) reestablishment request message; or
in case that the timer of a secondary cell group (SCG) expires, receiving, from the UE, SCG failure information.

24. The method of claim 21,
wherein the timer includes a T304, and
wherein the T304 is configured for each candidate cell in each cell group and at least one possible value of the T304 is ms50, ms100, ms150, ms200, ms500, ms1000, ms2000, and ms10000.

25. The method of claim 21,
wherein the timer of a secondary cell group (SCG) is stopped, upon an SCG release, and
wherein at least one of a T310 for a source special cell (SpCell), a T312 for the source SpCell, or a T390 for all access categories is stopped upon reception of the LTM cell switch command.

26. A user equipment (UE) in a wireless communication system, the UE comprising:
a transceiver; and
a processor configured to:
receive, from a base station, a control message including a layer 1/layer 2 triggered mobility (LTM) configuration comprising a timer per candidate cell per cell group,
receive, from the base station, an LTM cell switch command, and
start the timer for an LTM cell switch in the LTM configuration upon reception of the LTM cell switch command.

27. The UE of claim 26, wherein the processor further configured to:
in case that a radio resource control (RRC) reconfiguration message is applied due to an LTM cell switch execution without performing a random access procedure and the LTM cell switch is successfully completed, stop the timer, or
in case that a random access procedure is completed, stop the timer.

28. The UE of claim 26, wherein the processor further configured to:
in case that the timer of a master cell group (MCG) expires, initiate a radio resource control (RRC) reestablishment procedure, or
in case that the timer of a secondary cell group (SCG) expires, transmit SCG failure information.

29. The UE of claim 26,
wherein the timer includes a T304, and
wherein the T304 is configured for each candidate cell in each cell group and at least one possible value of the T304 is ms50, ms100, ms150, ms200, ms500, ms1000, ms2000, and ms10000.

30. The UE of claim 26,
wherein the timer of a secondary cell group (SCG) is stopped, upon an SCG release, and
wherein, in case that the LTM cell switch command is received, at least one of a T310 for a source special cell (SpCell), a T312 for the source SpCell, or a T390 for all access categories is stopped.

31. A base station in a wireless communication system, the base station comprising:
a transceiver; and
a processor configured to:
transmit, to user equipment (UE), a control message including a layer 1/layer 2 triggered mobility (LTM) configuration comprising a timer per candidate cell per cell group, and
transmit, to the UE, an LTM cell switch command;
wherein the timer for an LTM cell switch in the LTM configuration is started upon reception of the LTM cell switch command.

32. The base station of claim 31,
wherein, in case that a radio resource control (RRC) reconfiguration message is applied due to an LTM cell switch execution without performing a random access procedure and the LTM cell switch is successfully completed, the timer is stopped; or
in case that a random access procedure is completed, the timer is stopped.

33. The base station of claim 31, wherein the processor further configured to:
in case that the timer of a master cell group (MCG) expires, receive, from the UE, a radio resource control (RRC) reestablishment request message, or
in case that the timer of a secondary cell group (SCG) expires, receive, from the UE, SCG failure information.

34. The base station of claim 31,
wherein the timer includes a T304, and
wherein the T304 is configured for each candidate cell in each cell group and at least one possible value of the T304 is ms50, ms100, ms150, ms200, ms500, ms1000, ms2000, and ms10000.

35. The base station of claim 31,
wherein the timer of a secondary cell group (SCG) is stopped, upon an SCG release, and
wherein at least one of a T310 for a source special cell (SpCell), a T312 for the source SpCell, or a T390 for all access categories is stopped upon reception of the LTM cell switch command.
